(19) United States
(12) Patent Application Publication
(10) Pub. No.: US 2015/0030945 A1
(43) Pub. Date: Jan. 29, 2015

(54) FUEL CELL SYSTEM AND ITS USE

(71) Applicants: ElringKlinger AG, Dettingen (DE); CeramTec GmbH, Plochingen (DE)

(72) Inventors: Thomas Kiefer, Bad Urach (DE); Marco Hoffmann, Reutlingen (DE); André Weber, Karlsruhe (DE); Claus-Peter Kluge, Roeslau (DE)

(73) Assignees: ElringKlinger AG; CeramTec GmbH

(21) Appl. No.: 14/511,880

(22) Filed: Oct. 10, 2014

Related U.S. Application Data
(63) Continuation of application No. PCT/EP2013/057686, filed on Apr. 12, 2013.

(30) Foreign Application Priority Data
Apr. 13, 2012 (DE) 102012103189.4

(51) Int. Cl. H01M 8/06; H01M 8/10; H01M 8/24

(52) U.S. Cl. CPC H01M 8/0606; H01M 8/2465; H01M 8/1016; H01M 8/0618; H01M 2008/1293
USPC 429/412

(57) ABSTRACT

A fuel cell system is provided, including a fuel cell stack with a plurality of cathodes (30) and anodes (34), wherein an oxidizing gas containing oxygen is feedable to the stack on the cathode side and a fuel gas is feedable to the stack on the anode side, and a reformer for generating the fuel gas from a fuel. The fuel cell stack includes a catalytically active material (42) which is arranged in the anode-side regions such that the fuel gas flows through the material upstream of the anode (34), wherein the catalytically active material catalyzes the reaction of carbon monoxide and water to carbon dioxide and hydrogen.

### CROSS-REFERENCE TO RELATED APPLICATIONS

The present application is a continuation of international application number PCT/EP2013/057686, filed on Apr. 12, 2013, which claims priority to German patent application number 10 2012 103 189.4, filed Apr. 13, 2012, the entire specification of both being incorporated herein by reference.

### FIELD OF INVENTION

The present invention relates to a fuel cell system, comprising a fuel cell stack with a plurality of cathodes and anodes, wherein an oxidizing gas containing oxygen is feedable to the stack on the cathode side and a fuel gas is feedable to the stack on the anode side, and a reformer for generating the fuel gas from a fuel.

The invention also relates to the use of a fuel cell system of this type for generating electrical energy in a motor vehicle which comprises an internal combustion engine powered by the fuel.

### BACKGROUND

In order to be able to obtain electrical energy by means of a fuel cell from a fuel, as used, in particular, for the operation of motor vehicles (e.g. diesel fuel or petrol), a fuel gas with electrochemically convertible components must first be produced from the fuel. This is achieved in the fuel cell system of the type mentioned in the introduction by means of the reformer in that, for example, by partial oxidation or steam reforming of the fuel, a gas mixture also designated synthesis gas is produced which contains, inter alia, hydrogen and carbon monoxide. Further components of a fuel cell system of this type are typically a residual gas burner in which the fuel gas not converted in the fuel cell stack is combusted. The heat thereby generated is utilized to pre-heat the oxidizing gas (typically ambient air) by means of a layered structure heat-exchanger, before the gas is fed to the fuel cell stack on the cathode side.

The fuel cell stacks that are used in such systems are usually high temperature fuel cells, in particular, solid oxide fuel cells (SOFC). An oxide ceramic material which has a conductivity for oxygen ions above a particular temperature, in particular yttrium-stabilized zirconium dioxide (YSZ) serves as the electrolyte. When electrical energy is produced from hydrogen and carbon monoxide which are contained in the fuel gas produced by the reformer, the following anode reactions take place:

H₂+O²⁻→H₂O+2e⁻ (1)

CO+O²⁻→CO₂+2e⁻ (2)

The corresponding cathode reaction is:

1/2O₂+2e^{-→O}²⁻ (3)

It has been found in practice that the efficiency of fuel cell systems of the type mentioned in the introduction is significantly impaired by the sulfur content of conventional fuels, in particular diesel fuel. Even commercially available diesel fuel sold under the “sulfur-free” designation typically has a sulfur content of up to 10 ppm, which although tolerable for operation of the fuel cell stack at above approximately 900° C., at a lower operating temperature of less than 800° C., which is preferred due to general efficiency considerations, leads to significant output losses. Investigations by the inventors have found that, during operation of a solid oxide fuel cell at 750° C. with a fuel gas produced through reforming of normal diesel fuel with a sulfur content of 9 ppm, the power output of the fuel cell stack declines by more than 30% within four hours. The efficiency loss associated therewith calls into question the economic viability of the use of such fuel cell systems, for example, in motor vehicles.

Although desulfurization of the fuel gas within the fuel cell system is fundamentally possible, however, due to the associated design effort, maintenance and/or energy requirements (e.g. for hot gas desulfurization) particularly in motor vehicles, it is not economical to carry out.

It is the object of the present invention to propose a fuel cell system in which a loss of power at temperatures below 800° C. which is caused by sulfur in the fuel or the fuel gas, can be prevented or at least significantly reduced.

### SUMMARY OF THE INVENTION

According to the invention, this object is achieved in the fuel cell system of the type mentioned in the introduction in that the fuel cell stack comprises a catalytically active material which is arranged in the anode-side regions such that the fuel gas flows through the material upstream of the anode, said catalytically active material catalyzing the reaction of carbon monoxide and water to carbon dioxide and hydrogen.

Even if the exact mechanism responsible for the power fall-off caused by sulfur is not yet known, it is assumed in general that particular sulfur-containing compounds impede the catalytic activity of the anode material with regard to the reactions occurring at the anode (particularly the above reactions 1 and 2). However, relatively precise investigations have shown that, to an overwhelming degree, this sulfur contamination relates only to the production of electrical energy from carbon monoxide (reaction 2), i.e., the carbon monoxide of the fuel gas passes through the fuel cell stack largely unused and is combusted in the residual gas burner, whilst the production of electrical energy from hydrogen (reaction 1) still takes place more or less unhindered. The solution proposed according to the invention makes use of this finding in that with the additional catalytically active material in the anode-side regions of the fuel cell stack, the conversion to hydrogen of carbon monoxide, from which, in the presence of sulfur poisoning, the production of electrical energy can no longer be effectively carried out, is catalyzed:

CO+H₂O→CO₂+H₂ (4)

This conversion is known as a shift reaction. It is, in principle, reversible, and the formation of carbon dioxide and hydrogen is favored by a continuous supply of water. This water is formed in the anode regions of the fuel cell stack according to the anode reaction of hydrogen (reaction 1). However, without the catalytically active material provided according to the invention, the reaction rate is too low. In principle, reaction 4, like reaction 2, is itself also catalyzed by the anode material which in high temperature fuel cells typically contains nickel oxide as the catalyst. However, particularly in the case of nickel catalysts, a marked activity loss due to sulfur also occurs in respect of the shift reaction, whereas with the catalytically active material according to the present invention, this is not the case or only to a slight degree. According to the overall reaction from reactions 1 and 4, the fuel cell system according to the invention therefore indirectly enables the production of electrical energy from the carbon monoxide contained in the fuel gas, even in the case of sulfur poisoning of the catalytic activity of the anode material.

The invention also provides that the catalytically active material is arranged such that the fuel gas flows through it upstream of the anode. The catalytically active material is therefore not directly introduced into the anode, which is advantageous in that a possible unforeseeable influence of the catalytic activity of the anode itself is thereby prevented. Since the additional catalytically active material is provided independently of the anode (but in the immediate vicinity thereof), no changes to the established manufacturing processes for the anode are necessary, particularly since the anode is typically manufactured as an integral part of a cathode-electrolyte-anode unit.

Since the fuel gas flows through the catalytically active material upstream of the anode, a fuel gas with an altered composition reaches the anode, having the smallest possible proportion of carbon monoxide and the largest possible proportion of hydrogen.

In a preferred embodiment of the invention, the catalytically active material is arranged between the anode and an anode-side contact element. The anode-side contact element serves for electrical contacting of the anode and enables an even current flow over the anode surface. The arrangement of the catalytically active material between the anode and the anode-side contact element represents a very simple design solution which does not require a change to the anode nor to the contact element.

The anode-side contact element preferably comprises a mesh, braid or woven fabric of nickel or a nickel-containing alloy. Nickel mesh materials are typically used as contact elements in solid oxide fuel cells.

It is particularly favorable if the catalytically active material arranged between the anode and the contact element is present in the form of a ceramic paste. A paste of this type can level out unevenness in the surface structures of the anode and of the contact element and thus favors a contact between these two elements which maximizes its area and closeness.

In a further preferred embodiment of the invention, the catalytically active material itself forms the anode-side contact element or a coating on the anode-side contact element. In this case, the contact element fulfils two functions simultaneously, specifically, the electrical contacting of the anode and catalysis of the conversion of carbon monoxide and water to carbon dioxide and hydrogen in the fuel gas.

In a variant of the invention, the catalytically active material forms a porous ceramic solid body as the anode-side contact element. A contact element of this type made of the catalytically active material can be connected by suitable manufacturing methods, for example by a substance-to-substance bond to the anode, i.e., applied as a further layer onto the cathode-electrolyte-anode unit.

If the catalytically active material forms a coating on the anode-side contact element, this coating can be applied by means of a wet chemical process (e.g. dipping, printing or wet powder spraying), CVD, PVD or by electroplating, onto the anode-side contact element. In this case, the contact element itself can also be made of nickel or a nickel-containing alloy as described above, or from another suitable material.

The catalytically active material according to the present invention can comprise as the actual catalyst, in principle, any element or any compound which catalyzes the shift reaction, even in the presence of sulfur in the fuel gas. The catalytically active material comprises, in particular, one or more metals from groups 8 to 12, the lanthanides and/or their compounds, in particular their oxides, the catalytic activity of which for the reaction of carbon monoxide and water to carbon dioxide and hydrogen is not decreased by the presence of sulfur in the fuel gas, or is only decreased to a smaller extent than is the catalytic activity of the anode for this reaction. The anode material of high temperature fuel cells usually contains nickel oxide as the catalyst, the catalytic activity of which for the shift reaction (as well as for the electrochemical conversion of carbon monoxide) is severely impaired by sulfur.

In preferred embodiments of the invention, the catalytically active material comprises cerium, platinum, palladium, rhodium, ruthenium, iron, cobalt, copper, silver, gold and/or tin, and/or their oxides. A particularly preferred catalyst comprises the catalytically active material cerium and/or cerium dioxide (CeO₂), which can be doped, particularly with gadolinium, yttrium, zirconium and/or calcium. It has been found that these metals or oxides also retain a significant activity for the catalysis of the shift reaction, even in the presence of sulfur in the fuel gas.

In this case, the catalytically active material can either be single-phase (e.g. metallic cerium, a cerium alloy or doped cerium dioxide) or can be present as a multi-phase system in which at least one phase contains cerium (e.g. a cermet in which metallic cerium and cerium dioxide are present together).

The catalytically active material according to the present invention can be made exclusively of the aforementioned metals and/or compounds, particularly if the material is used as a coating on the anodic contact element. In particular, however, if the catalytically active material consists of a ceramic paste or a porous ceramic solid body, it is preferable if, in addition to the actual catalyst, the material also comprises one or more carrier materials. Such carrier materials enable the necessary properties of the material, apart from the catalytic activity, to be preserved and optimized, i.e., in particular, mechanical strength, porosity, consistency (in the case of a paste) and electrical conductivity. Primarily, however, the carrier material results in an even distribution of the catalyst over as large an area as possible and prevents agglomeration.

Carrier materials that are preferred within the context of the present invention include zirconium dioxide, yttrium-stabilized zirconium dioxide, nickel oxide, titanium dioxide, aluminum oxide, magnesium oxide, zeolites, hexaaluminates and perovskites, which can be doped. Particularly favorable is the use of yttrium-stabilized zirconium dioxide and nickel oxide as carrier materials since this essentially also corresponds to the typical composition of the anode material and, consequently, considerable material homogeneity can be achieved between the anode and the catalytically active material arranged on the inflow side. In this regard, the nickel oxide ensures, beyond a particular proportion, the electrical conductivity of the carrier material.

The proportion of the actual catalyst in the catalytically active material can be varied over a wide range, although the optimum proportion depends both on the form of the catalytically active material (solid body, paste or coating) as well as on the intended operating conditions of the fuel cell system. Thus as mentioned above, in some cases, the catalytically active material can be made entirely of the actual catalyst whilst, in other cases, just very small quantities in the region of approximately 0.1% by weight are sufficient.

In many cases, it is preferred if the metal or metals of groups 8 to 12 and the lanthanides and/or compounds thereof are contained in the catalytically active material in a proportion from 1% to 15% by weight, in particular from 4% to 10% by weight. For example, a catalytically active material in the form of a ceramic paste can contain 4% to 10% by weight of cerium dioxide and, as the carrier material, 90% to 96% by weight of yttrium-stabilized zirconium dioxide and nickel oxide in the ratio of approximately 3:5.

It has been found to be particularly advantageous, in the context of the present invention, to use a mixture of cerium dioxide (e.g. doped with gadolinium) and nickel oxide preferably in the ratio of approximately 1:1. It has been found that, compared with pure doped cerium oxide, such a material has a higher catalytic activity with regard to the shift reaction and leads to an approximately 25% improvement in the efficiency of the fuel cell. This is surprising in that nickel oxide itself, when used as an anode material, typically undergoes a loss of activity due to sulfur (see above). The precise method of operation of such mixtures of cerium oxide and nickel oxide in which a suitable mixed oxide is possibly also present has not yet been fully clarified, although it is assumed that the presence of 3-phase interfaces (cerium oxide/nickel oxide/fuel gas) plays a part.

The catalytically active material can contain, particularly when present in the form of a paste or a coating, further ingredients for setting the required properties, particularly organic binding agents and/or solvents.

In the reformer of the fuel cell system according to the invention, preferably a steam reforming process, autothermal reforming or partial oxidation takes place, wherein a fuel gas containing hydrogen and carbon monoxide is generated from the fuel. Hydrogen and carbon monoxide are typically present in the fuel gas in approximately equal proportions (typically each in the region of approximately 15%). The fuel gas also contains carbon dioxide, water and residual hydrocarbons.

The fuel in the context of the present invention comprises a mixture of aliphatic and/or aromatic hydrocarbons, wherein the fuel is selected, in particular, from diesel fuel and petrol.

The fuel typically has a sulfur content of up to 15 ppm and particularly up to 10 ppm.

The invention also relates particularly to the use of the fuel cell system of the type described in the introduction for generating electrical energy in a motor vehicle which comprises an internal combustion engine powered by the fuel. Particularly advantageous is the use of the fuel cell system as an APU (auxiliary power unit) in a commercial vehicle powered by diesel fuel.

### BRIEF DESCRIPTION OF THE DRAWINGS

These and other advantages of the invention will now be described in greater detail based on the following examples and making reference to the drawings, in which:

FIG. 1 shows a schematic representation of an exemplary embodiment of the fuel cell system according to the invention; and

FIG. 2 shows a schematic cross-section through a single fuel cell according to an exemplary embodiment of the invention.

### DETAILED DESCRIPTION OF THE INVENTION

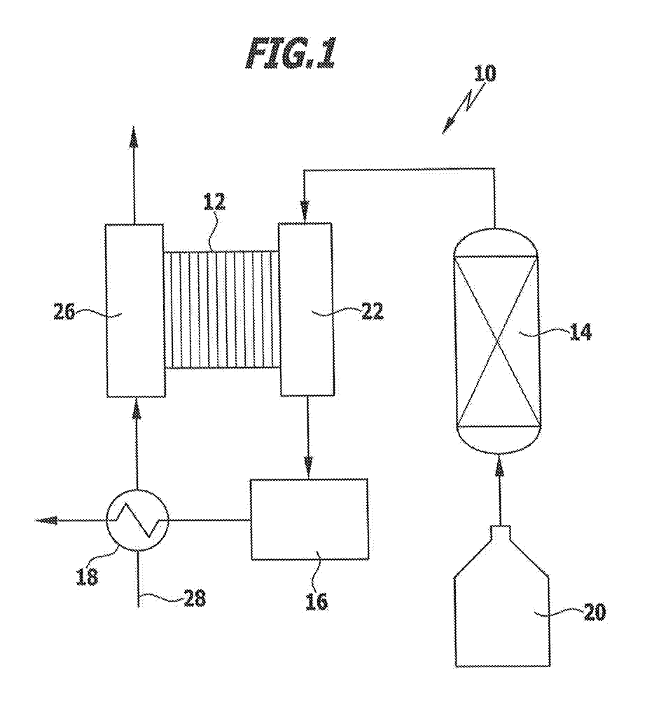

FIG. 1 shows schematically a fuel cell system according to one embodiment of the invention which is identified overall as 10. The fuel cell system 10 comprises a fuel cell stack 12 with a plurality of cathodes and anodes, a reformer 14, a residual gas burner 16 and a layered structure heat-exchanger 18.

During operation of the fuel cell system 10, fuel (e.g. diesel fuel) is fed from a fuel tank 20 to the reformer 14 (e.g. a steam reformer) where a fuel gas containing hydrogen and carbon monoxide is generated from the fuel. The fuel gas is fed to the anode side 22 of the fuel cell stack 12. By means of a catalytically active material which is arranged in the anode-side regions of the fuel cell stack 12 in each case upstream of the anode (not shown in FIG. 1), the complete or partial conversion of the carbon monoxide contained in the fuel gas with water to carbon dioxide and hydrogen is catalyzed. The hydrogen is electrochemically converted at the anodes of the fuel cell stack 12. Unconverted fuel gas which is contained in the anode output gas is subsequently combusted in the residual gas burner 16.

Ambient air 28 is fed to the cathode side 26 of the fuel cell stack 12 as the oxidizing gas, wherein the ambient air 28 is previously pre-heated by means of the waste heat from the residual gas burner 26 by means of the layered structure heat-exchanger 18.

Due to the conversion of carbon monoxide and water to carbon dioxide and hydrogen with the aid of the catalytically active material, a direct electrochemical conversion of carbon monoxide, which is severely impaired by sulfur-containing compounds in the fuel gas, is not required in the fuel cell system 10. In this way, the fuel cell system 10 can also be operated with a fuel having a sulfur content of e.g. up to 10 ppm at a high level of efficiency, specifically at temperatures of below 800° C.

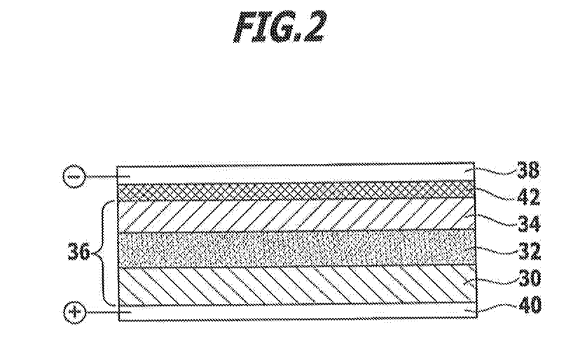

FIG. 2 shows a schematic cross-section through an individual electrochemical cell of the fuel cell stack according to one embodiment of the invention in which a cathode 30, an electrolyte 32 and an anode 34 are arranged in layers and form a cathode-electrolyte-anode unit 36. On the side of the cathode 30, a cathode-side contact element 38 and, on the side of the anode 34, an anode-side contact element 40 are arranged, which serve for the electrical contacting of the respective electrodes.

Arranged between the anode 34 and the anode contact element 38 is a catalytically active material 42, i.e., during operation of the fuel cell system, the fuel gas flows through the catalytically active material 42 upstream of the anode 34. Herein, the catalytically active material 42 promotes the reaction of carbon monoxide with water to carbon dioxide and hydrogen.

In the exemplary embodiment shown in FIG. 2, the catalytically active material 42 is present in the form of a ceramic paste, which enables direct and large-area contact both with the anode 34 and also with the anode-side contact element 38. The ceramic paste can comprise, for example, 4% to 10% by weight of cerium dioxide as the actual catalyst and 90% to 96% by weight of yttrium-stabilized zirconium dioxide and nickel oxide in a ratio of approximately 3:5 as the carrier material. Alternatively, the paste can consist purely of the catalyst, i.e., for example, cerium dioxide.

The anode 34 can be made, for example, from a mixture of yttrium-stabilized zirconium dioxide (YSZ) and nickel oxide and the anodic contact element 38 is, for example, a nickel mesh.

As an alternative to the exemplary embodiment shown in FIG. 2, the catalytically active material can also itself form the anode-side contact element or a coating on the anode-side contact element.

An actual comparison of the efficiencies of a fuel cell system according to the invention with a fuel cell system according to the prior art was carried out using the following exemplary system:

Fuel cell type: SOFC

Fuel gas: reformate from diesel fuel with approximately 9 ppm sulfur

Operating temperature: 750° C.

Anode material: NiO/YSZ

Anode contact element: Ni mesh

A ceramic paste made of cerium dioxide (CeO₂) was applied as the catalytically active material according to the invention between the anode material and the anode-side contact element by means of roller coating, specifically in a quantity of between 0.012 g/cm² and 0.024 g/cm². A comparison system was operated under the same conditions but without this paste.

After an operating time of 40 h, in the comparison system the initial nominal output had fallen by approximately 50% and no further conversion of carbon monoxide took place (same CO concentration in the exhaust gas as in the fuel gas according to a GC measurement).

In the system according to the invention, the nominal output fell after the same operating period (40 h) by only approximately 25% and then remained stable at this level. Carbon monoxide continued to be converted until the end of the measurement (100 h), which demonstrates that despite the sulfur content in the fuel gas, the shift reaction continues to be catalyzed by the catalytically active material according to the invention.

A still higher efficiency of the fuel cell system according to the invention was achieved when a paste containing a mixture of doped cerium dioxide and nickel oxide was used as the catalytically active material. A paste of this type comprises, for example, 33% by weight of nanoscale CeO₂ (doped with Gd), 33% by weight of nanoscale NiO, approximately 30% to 32% by weight of terpineol as a solvent and approximately 2% to 4% ethyl cellulose as a binding agent.

That which is claimed:

1. A fuel cell system, comprising a fuel cell stack with a plurality of cathodes and anodes, wherein an oxidizing gas containing oxygen is feedable to the stack on the cathode side and a fuel gas is feedable to the stack on the anode side, and a reformer for generating the fuel gas from a fuel,
characterized in that the fuel cell stack comprises a catalytically active material which is arranged in the anode-side regions such that the fuel gas flows through the material upstream of the anode, said catalytically active material catalyzing the reaction of carbon monoxide and water to carbon dioxide and hydrogen.

2. The fuel cell system according to claim 1, wherein the catalytically active material is arranged between the anode and an anode-side contact element.

3. The fuel cell system according to claim 2, wherein the anode-side contact element comprises a mesh, braid or woven fabric of nickel or a nickel-containing alloy.

4. The fuel cell system according to claim 1, wherein the catalytically active material is present in the form of a ceramic paste.

5. The fuel cell system according to claim 1, wherein the catalytically active material forms an anode-side contact element or a coating on an anode-side contact element.

6. The fuel cell system according to claim 5, wherein the catalytically active material forms a porous ceramic solid body as the anode-side contact element.

7. The fuel cell system according to claim 5, wherein the catalytically active material is applied by means of a wet chemical process, CVD, PVD or by electroplating as a coating onto the anode-side contact element.

8. The fuel cell system according to claim 1, wherein the catalytically active material comprises one or more metals from groups 8 to 12, the lanthanides and/or compounds thereof, in particular oxides thereof, the catalytic activity of which for the reaction of carbon monoxide and water to carbon dioxide and hydrogen is not decreased by the presence of sulfur in the fuel gas, or is only decreased to a smaller extent than is the catalytic activity of the anode for this reaction.

9. The fuel cell system according to claim 8, wherein the catalytically active material comprises cerium, platinum, palladium, rhodium, ruthenium, iron, cobalt, copper, silver, gold and/or tin, and/or their oxides.

10. The fuel cell system according to claim 9, wherein the catalytically active material comprises cerium and/or cerium dioxide, which can be doped, particularly with gadolinium, yttrium, zirconium and/or calcium.

11. The fuel cell system according to claim 1, wherein the catalytically active material is present as a single-phase or multi-phase system.

12. The fuel cell system according to claim 8, wherein the catalytically active material further comprises one or more carrier materials that are preferably selected from zirconium dioxide, yttrium-stabilized zirconium dioxide, nickel oxide, titanium dioxide, aluminum oxide, magnesium oxide, zeolites, hexaaluminates and perovskites, which can be doped.

13. The fuel cell system according to claim 8, wherein the metal or metals of groups 8 to 12 and the lanthanides and/or compounds thereof are contained in the catalytically active material in a proportion from 1% to 15% by weight, in particular from 4% to 10% by weight.

14. The fuel cell system according to claim 8, wherein the catalytically active material comprises a mixture of cerium dioxide, which can be doped, and nickel oxide, preferably in the ratio of approximately 1:1.

15. The fuel cell system according to claim 1, wherein in the reformer, a steam reforming process, autothermal reforming or partial oxidation takes place, and wherein the fuel gas contains hydrogen and carbon monoxide.

16. The fuel cell system according to claim 1, wherein the fuel comprises a mixture of aliphatic and/or aromatic hydrocarbons, and is selected, in particular, from diesel fuel and petrol.

17. The fuel cell system according to claim 16, wherein the fuel has a sulfur content of up to 15 ppm and particularly up to 10 ppm.
